(19) United States
(12) Patent Application Publication
(10) Pub. No.: US 2004/0107626 A1
(43) Pub. Date: Jun. 10, 2004

(54) Attachable fish attractant and method

(76) Inventor: John Timothy Sims, Bawbridge, GA (US)

Correspondence Address: John Wiley Horton, Attorney, Pennington, Moore, Wilkinson, Bell & Dunbar, P.A., P. O. Box 10095, Tallahassee, FL, 32302-2095, US

(21) Appl. No.: 10/677,564

(22) Filed: Oct. 2, 2003

Related U.S. Application Data
(63) Continuation-in-part of application No. 10/202,715, filed on Jul. 24, 2002, now abandoned.

(51) Int. Cl. A01K 85/00

(52) U.S. Cl. 43/42.06

(57) ABSTRACT

A fish attractant slug which can be easily placed on a fishing line in close proximity to a bait. The slug includes a center bore and an outside surface. The outside surface preferably opens into a spiral groove which connects with the center bore. In order to install the device, the user wraps the fishing line around the spiral groove, then pulls it taut. The tension placed on the fishing line pulls the line inward until it rests within the center bore. In use, the attractant slug slowly dissolves to release the fish attractant it contains. The installation method allows a user to place an attractant slug on the fishing line without untying the bait.

### CROSS-REFERENCES TO RELATED APPLICATIONS

This application is a continuation-in-part of U.S. application Ser. No. 10/202,715, which was filed on Jul. 24, 2002.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of fishing equipment. More specifically, the invention comprises a molded fish attractant which can be easily attached to a fishing line, along with a method for its use.

2. Description of the Related Art

Artificial baits have been in common use for many years. One such device is illustrated in FIG. 1. Artificial lure 10 is shaped to mimic the action of a bait fish as it is pulled through the water. Fishing line 14 is typically connected on one end to a fishing rod. The other end is tied to the leading portion of swivel 16. The trailing portion of swivel 16 is tied to a second much shorter piece of fishing line, denoted leader 18. The swivel shown is merely representative of the connecting hardware in common use.

Leader 18 is typically quite short, extending as little as 12 to 24 inches. It is often made from heavier gage line than fishing line 14, so that it can withstand a bite or other rough treatment in close proximity to the fish sought. In some cases, leader 18 may even be made of steel wire. Leader 18 is attached to artificial lure 10 at attachment ring 38. A number of hooks 12 extend outward from artificial lure 10.

FIG. 2 illustrates a second type of prior art artificial bait—worm 20. Worm 20 is typically molded from a pliable plastic or rubber. An offset hook 22 is inserted through worm 20, leaving hook ring 24 protruding out the forward portion. Leader 18 is then tied or otherwise attached to hook ring 24.

The use of scent-type attractants is also known in the prior art. These formulations, such as fish oil, have been inserted into a reservoir within worm 20, where they leak out through a small orifice. Fish oil reservoirs have also been provided within artificial lures such as the one depicted in FIG. 1.

### BRIEF SUMMARY OF THE INVENTION

A fish attractant slug made from a compound of fish attracting scents. The slug includes a helix allowing it to be placed on a fishing line without detaching the bait. The slug includes a center bore and an outside surface. The outside surface opens into a helix (other embodiments are also disclosed) which connects with the center bore. In order to install the device, the user wraps the fishing line around the spiral groove, then pulls it taut. The tension placed on the fishing line pulls the line inward until it rests within the center bore.

The center bore is made large enough to pass over swivels and similar attachment hardware found on fishing lines. This fact is particularly advantageous when the user wishes to change or replenish the attractant slug. It is common for the artificial lure to be trolled behind a moving boat. It may be one hundred feet or more astern. To add a new attractant slug to the lure, the user attaches the slug to the line close to the point where the line enters the rod. The slug then passes down the line, enters the water, and travels toward the lure. The center bore allows the slug to pass along until it comes to rest against the artificial lure. It is then propelled through the water at the same velocity as the lure, whereupon the turbulent flow of water over the slug causes the attractant material to dissolve. Fish attractant is thereby dispersed over the artificial lure.

### BRIEF DESCRIPTION OF THE SEVERAL VIEWS OF THE DRAWINGS

FIG. 1 is an isometric view, showing a prior art artificial lure.

FIG. 2 is an isometric view, showing a prior art worm.

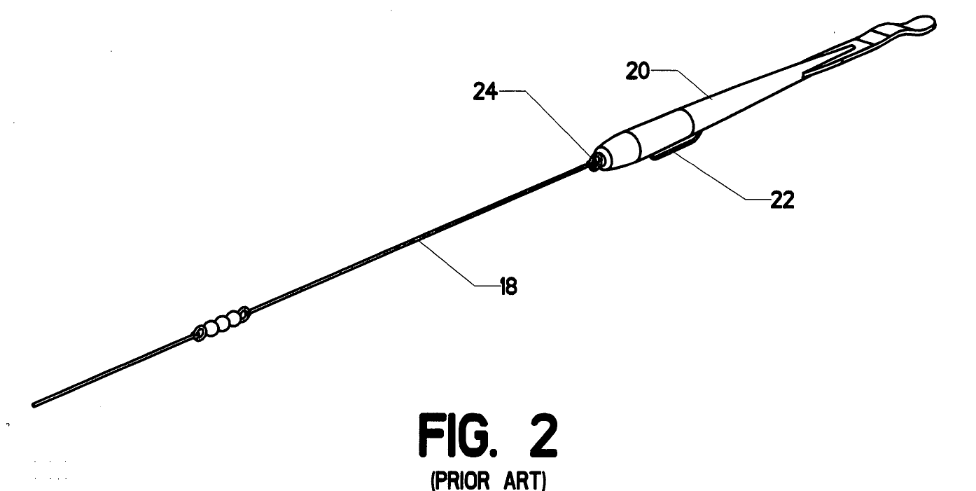

FIG. 3 is an isometric view, showing the present invention.

FIG. 4 is an isometric view, showing the installation of the present invention.

FIG. 5 is an isometric view, showing the installation of the present invention.

FIG. 6 is an isometric view, showing the installation of the present invention.

FIG. 7 is an isometric view, showing the installation of the present invention.

FIG. 8 is an isometric view, showing the present invention installed on an artificial lure.

FIG. 9 is an isometric view, showing the present invention installed on a worm.

FIG. 10 is an isometric view, showing the use of a zig-zag groove.

FIG. 11 is an isometric view, showing the use of an S-curve groove.

FIG. 12 is an isometric view, showing the use of a crescent groove.

FIG. 13 is an isometric view, showing the use of a chevron groove.

FIG. 14 is an isometric view, showing an artificial lure being trolled.

FIG. 15 is an isometric view, showing the loading of an attractant slug onto the trolling line.

FIG. 16 is an isometric view, showing the attractant slug traveling toward the artificial lure.

FIG. 17 is an isometric view, showing the operation of the attractant slug.

### REFERENCE NUMERALS IN THE DRAWINGS

10 artificial lure

12 hook

14 fishing line

16 swivel

18 leader

20 worm

22 offset hook

24 hook ring

26 attractant slug

28 body

30 center bore

32 spiral groove

34 entry slot

36 exit slot

38 attachment ring

40 zig-zag groove

42 S-curve groove

44 crescent groove

46 chevron groove

48 glitter

50 scent stream

52 rod

### DETAILED DESCRIPTION OF THE INVENTION

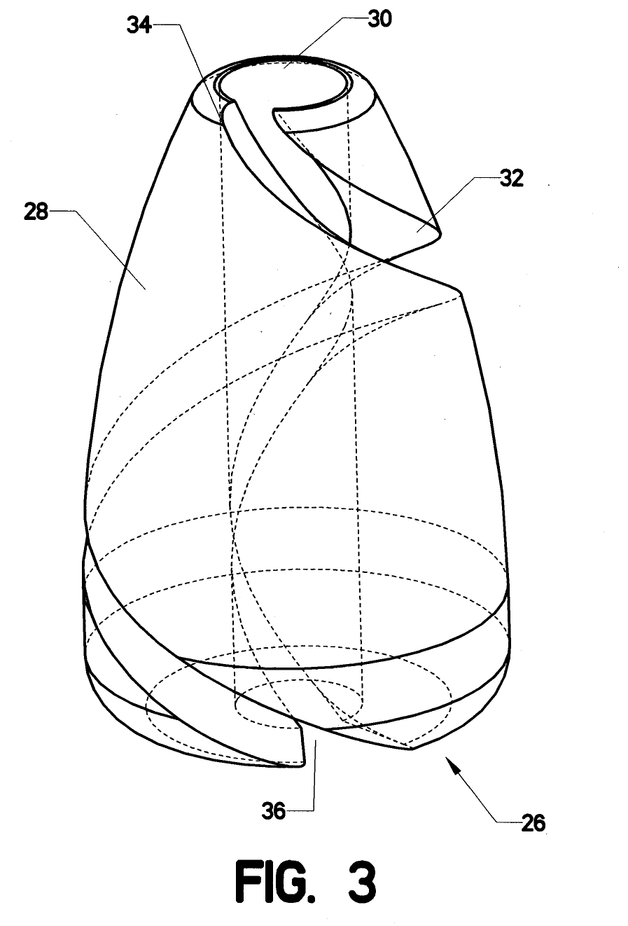

The present invention is an attachable fish attractant which slowly disperses the attracting ingredients into the water during use. FIG. 3 depicts attractant slug 26. It is formed as body 28, having a central bore 30 running from its upper extreme to its lower extreme (with “upper” and “lower” being used in the context of the orientation shown in the view). The outer surface is formed in a smooth hydrodynamic shape. Spiral groove 32 is cut into the outer surface. The inner portion of spiral groove 32 opens into central bore 30. The upper extreme (in the view as shown) of spiral groove 32 terminates in entry slot 34, with the lower extreme terminating in exit slot 36.

In use, attractant slug 26 will preferably be placed in close proximity to the bait. The ideal location is immediately ahead of the bait, attached to leader 18. Attractant slug 26 is made of a material which slowly dissolves in water. Thus, after a short period of use, attractant slug 26 will dissolve and need to be replaced. It is obviously desirable to be able to replace attractant slug 26 without having to detach the bait from the leader. Spiral groove 32 is provided for this purpose, as will be explained in the following.

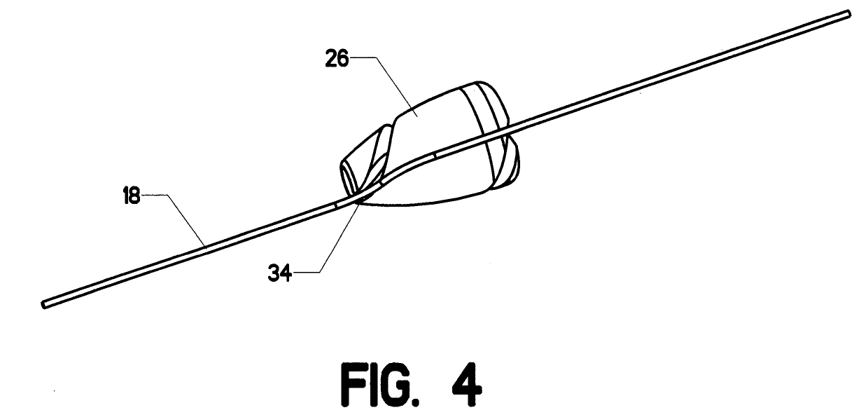

FIGS. 4 through 7 show the sequence of placing attractant slug 26 on leader 18 (or any other type of fishing line). Throughout the following descriptions, those skilled in the art will realize that the use of leader 18 is optional. In many applications, fishing line 14 will be directly attached to the lure without the use of a leader. Thus, for purposes of attaching the invention, a leader or a fishing line are interchangeable.

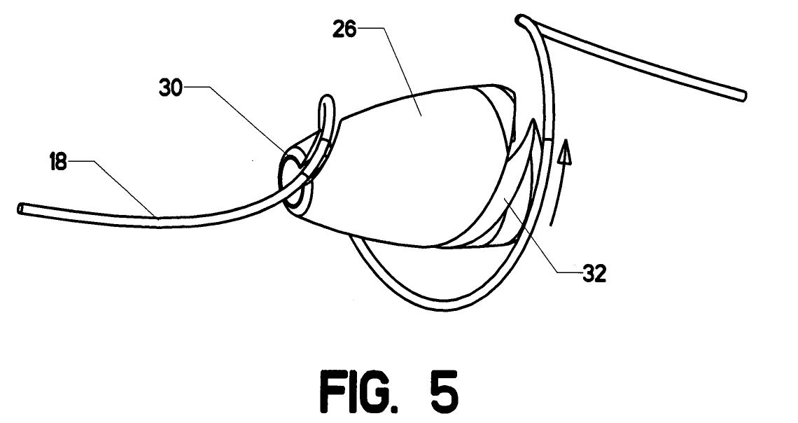

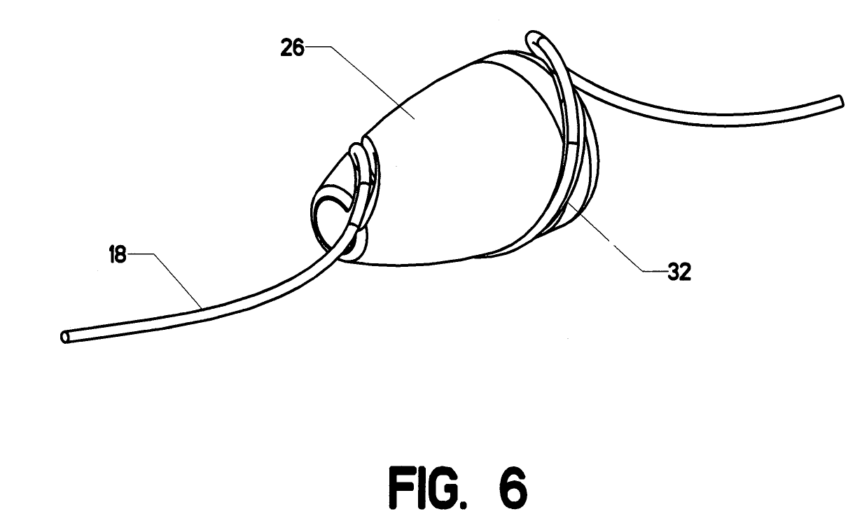

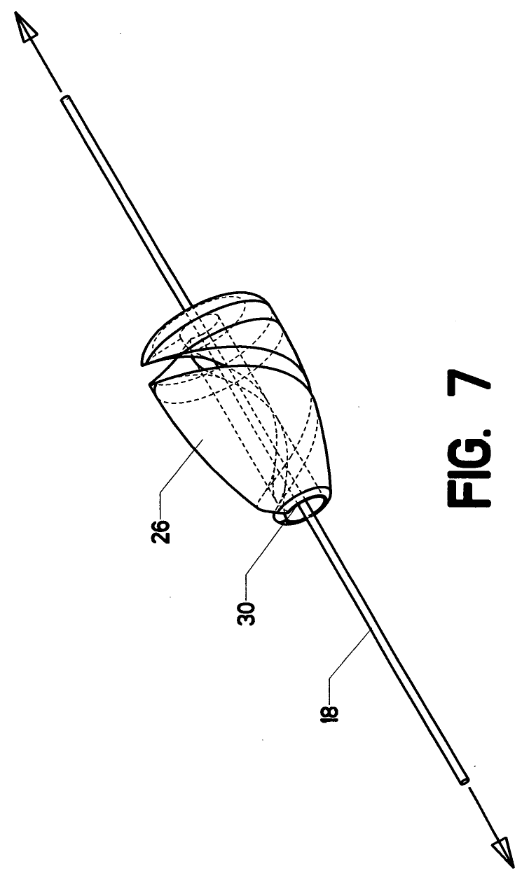

In FIG. 4, leader 18 has been passed through entry slot 34 and into the leading portion of spiral groove 32. The user then wraps leader 18 around spiral groove 32, as shown in FIG. 5. In FIG. 6, leader 18 has been wrapped completely around spiral groove 32, so that a portion of leader 18 lies entirely within spiral groove 32. At this point, the user pulls on the free ends of leader 18 to place tension on the portion lying within spiral groove 32. This action results in leader 18 being drawn down into center bore 30, as shown in FIG. 7. Once leader 18 has been drawn into center bore 30, it will not tend to reenter spiral groove 32. Thus, attractant slug 26 is securely fastened to leader 18.

Once in the state shown in FIG. 7, attractant slug 26 is free to move back and forth on leader 18. It may then be pushed along leader 18 until it comes up against the bait. As the bait is then dragged through the water, hydrodynamic forces will tend to keep attractant slug 26 positioned immediately ahead of the bait, where it will slowly dissolve and release the attractant materials over the bait.

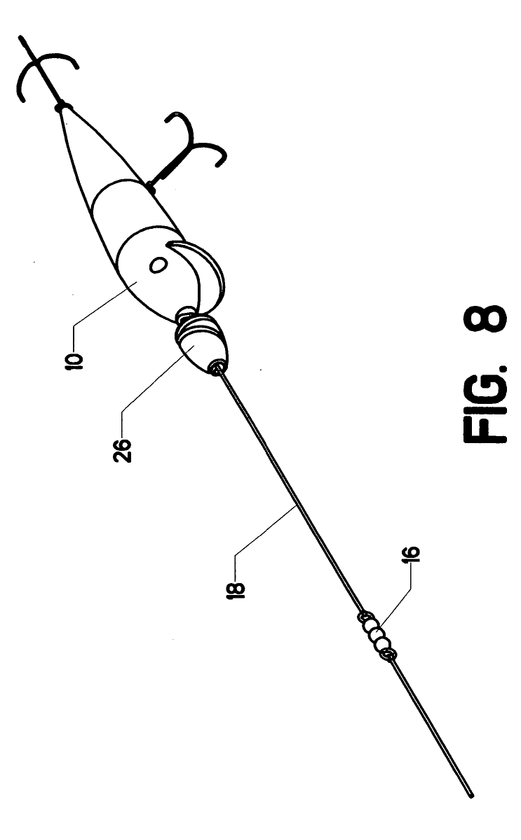

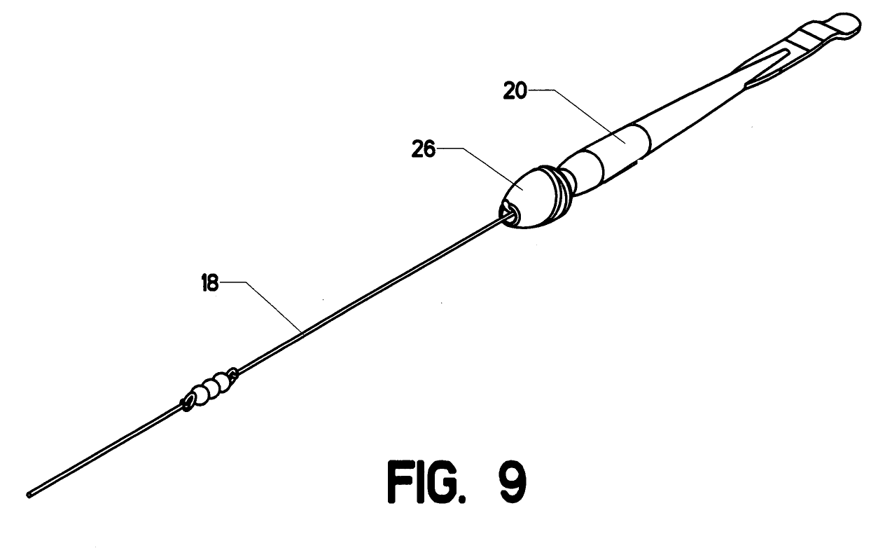

FIG. 8 shows attractant slug 26 in position in front of artificial lure 10. FIG. 9 shows attractant slug 26 in position in front of worm 20. Of course, as those skilled in the art will know, attractant slug 26 could just as easily be placed in front of a natural bait, such as a shrimp or a cigar minnow. The reader will appreciate that what was denoted as the upper extreme of attractant slug 26 in FIG. 3 is more aptly referred to as the leading extreme in FIGS. 8 and 9 (with respect to the direction of towing the bait). Likewise, what was denoted as the lower extreme in FIG. 3 is more appropriately referred to as the trailing extreme in FIGS. 8 and 9.

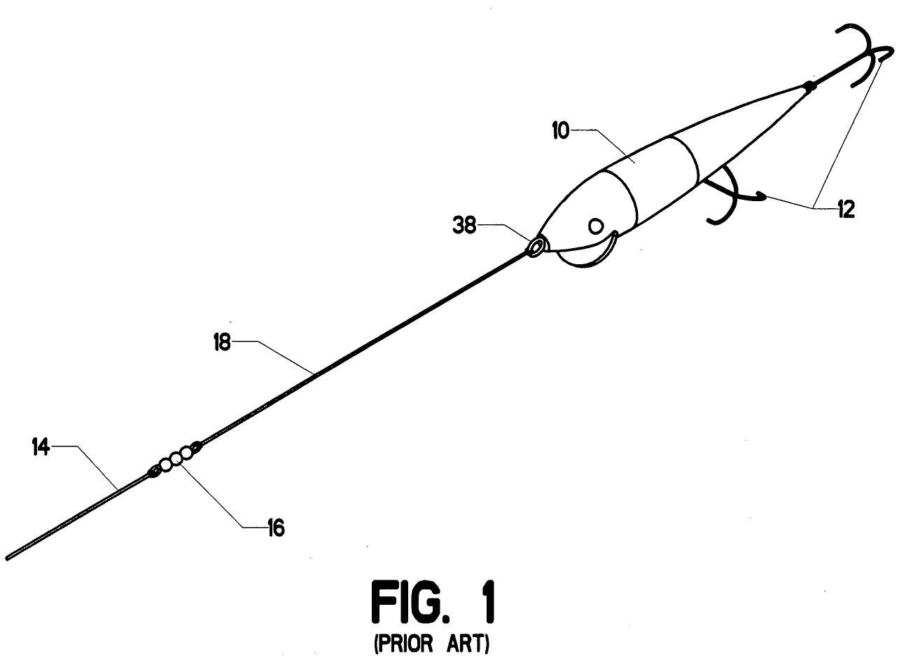

Returning now to FIG. 3, those skilled in the art will also realize that the diameter of center bore 30 can be increased substantially without affecting the operation of the device. Looking at FIG. 1, the enlargement of center bore 30 allows attractant slug 26 to pass easily over swivel 16. The center bore can likewise pass over other familiar line hardware, such as “sinkers” (weights), clips, and similar fasteners. All these items will be generically referred to as “line hardware.” The ability of the center bore to pass over line hardware is important for the following reason: When a lure is towed in a trolling fashion, it may be 50 yards or more behind the boat. In order to replace a conventional attractant, the lure must be reeled in, serviced, and allowed to trail back out to its original position (a time consuming process). Using the present invention—with an appropriately sized center bore 30—the user simply places attractant slug 26 on fishing line 14 near the point where it attaches to the fishing rod. Gravity (sometimes with help from the user) cause attractant slug 26 to slide down the line and into the water. Once attractant slug 26 is in the water, hydrodynamic forces slide it aft along the fishing line until it comes to rest against the front of the bait. Thus, the user can replace the attractant slug, or add additional attractant slugs, without interrupting the trolling.

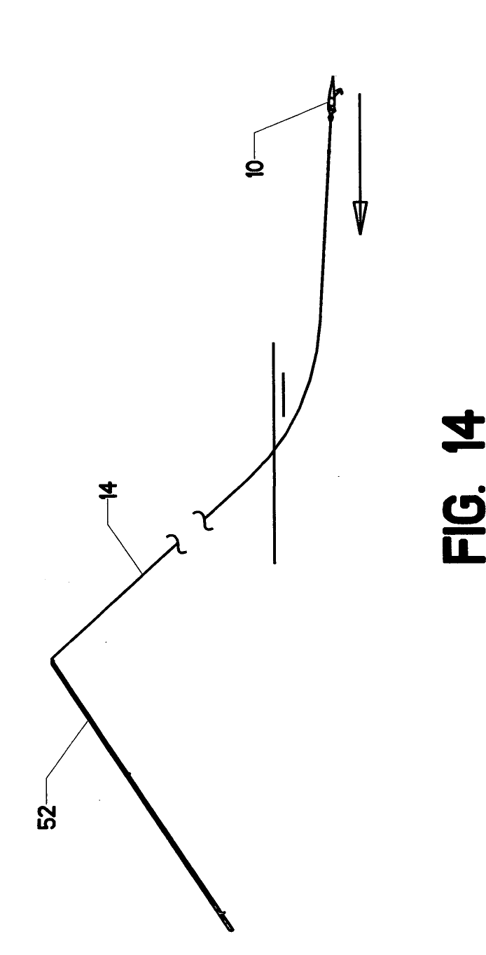

FIGS. 14-17 illustrate this process. FIG. 14 schematically shows a trolling set-up. Fishing line 14 extends from rod 52 back to artificial lure 10. The discontinuity is shown in the line because—in reality—the lure may be 50 yards or more from the rod. The rod is typically located in a boat which is being propelled forward at relatively low speed.

The use of an attractant is desirable for trolling. The prior art allows an attractant to be added to the lure. However, trolling is often conducted for an hour or more. The attractant must be periodically renewed. In the prior art, this means reeling in the lure, replacing the attractant, and playing it back out to the trolling position. Such a cycle consumes ten to fifteen minutes.

The user may also wish to change the attractant. If it becomes apparent that fish are around, but they are not hitting the lure, the user will want to make a change. In the prior art, such a change also required reeling in the lure. The present invention eliminates this problem.

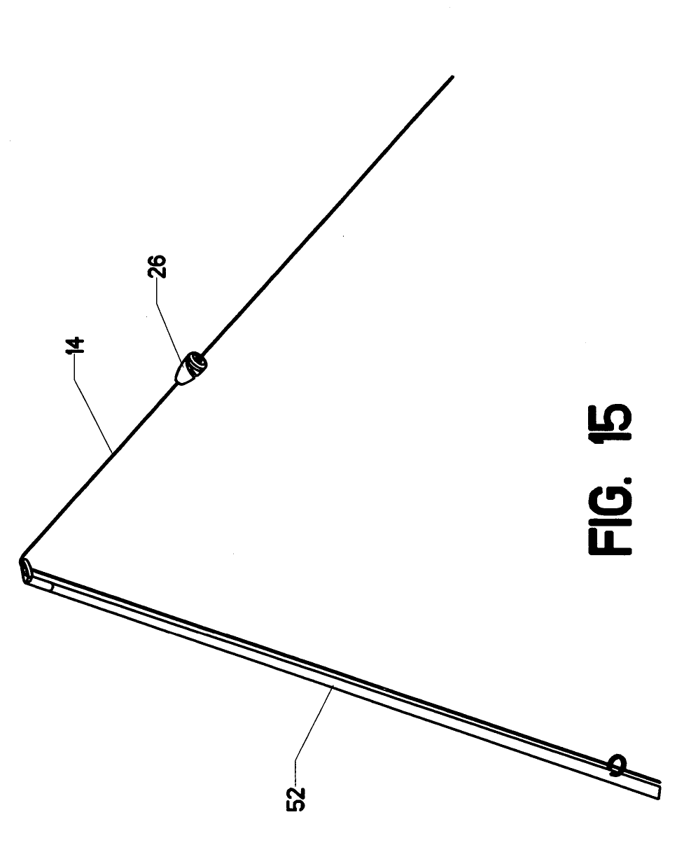

FIG. 15 shows the portion of fishing line 14 in close proximity to rod 52. The user places attractant slug 26 on this portion of the line, as previously described (FIGS. 4 through 7). Gravity then pulls the slug down the line until it enters the water. Once the slug enters the water, hydrodynamic drag will push it along the line toward the lure.

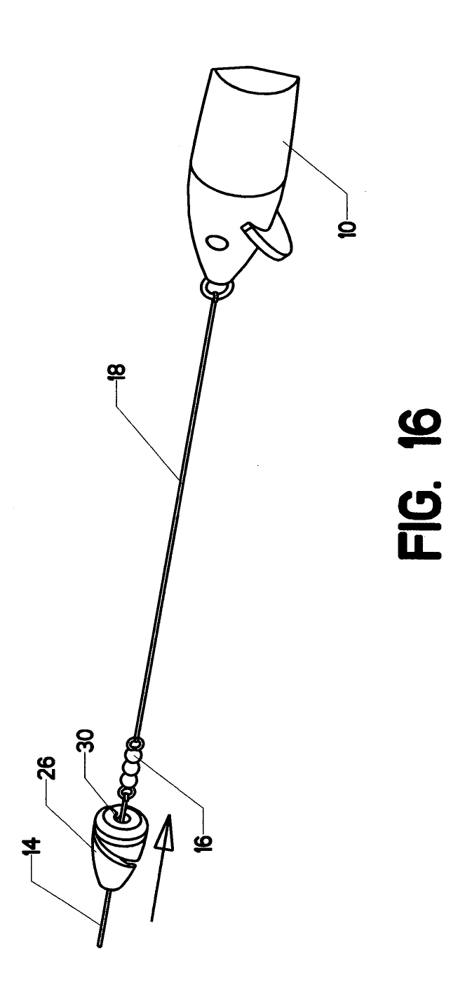

FIG. 16 shows the slug moving along the line toward the lure. The reader will observe how center bore 30 is large enough to pass over the line hardware. The slug continues until it comes up against the leading portion of artificial lure 10.

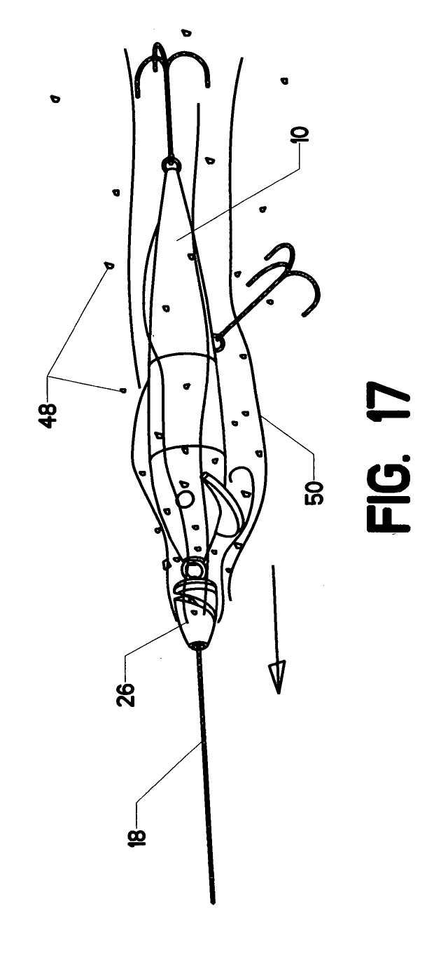

FIG. 17 shows attractant slug 26 in position against the front of artificial lure 10. Once the slug reaches this position, it is propelled forward by the lure. The water moving over the slug then begins dissolving the material comprising the slug. The reader will observe how the slug expands toward a truncated trailing end. This truncated trailing end cause turbulent flow over the trailing end of the slug and the leading extreme of the lure. The lure is thereby enveloped in scent streams 50.

Other attractant materials can be embedded within the slug It is known, for example, that fish respond to bright flashes. It may therefore be desirable to embed glitter particles in the attractant slug. These break free as the slug dissolves. They are shown as glitter 48 in FIG. 17. The position and shape of the attractant slug causes the glitter to flow around the lure in a turbulent fashion.

Returning now to FIG. 3, those skilled in the art will realize that the interaction of spiral groove 32 and center bore 30 allows the convenient installation of attractant slug 26 on virtually any type of flexible line. Those skilled in the art will realize, however, that the helical form of spiral groove 32 illustrated is not the only shape that can perform this function. The key is to provide a slot connecting the outer surface of attractant slug 26 with center bore 30, which is sufficiently curved (non-straight) to require the fishing line to be manipulated into a curved shape in order to enter center bore 30. In use, the fishing line is maintained in tension. Thus, it is unlikely that it will lapse into a curved shape which would allow it to escape center bore 30.

A simple crescent shape can be substituted for spiral groove 32. Additional shapes include a zig-zag, an S-curve, and a chevron. However, as best seen in FIG. 5, the use of the helical shape allows the user to naturally wrap the fishing line into spiral groove 32. This is true because persons familiar with fishing equipment are accustomed to wrapping line around a spool. Thus, the helical shape constitutes the preferred embodiment.

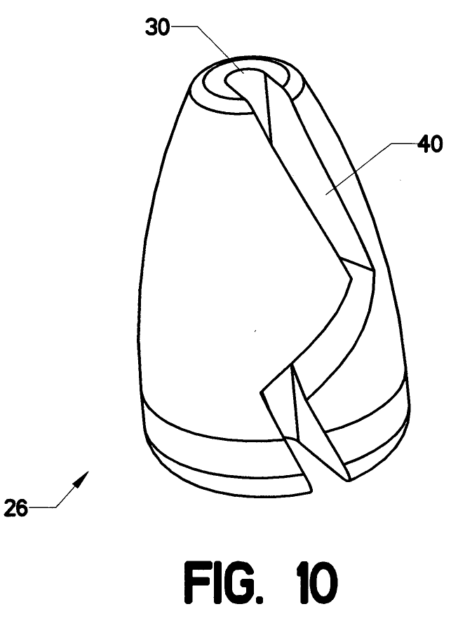

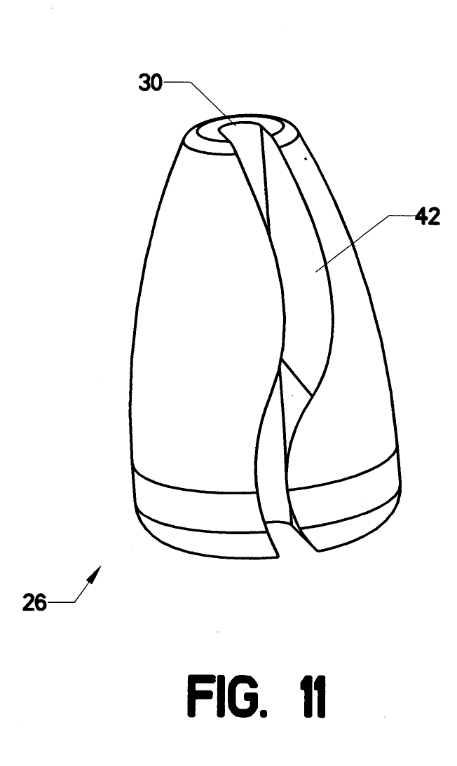

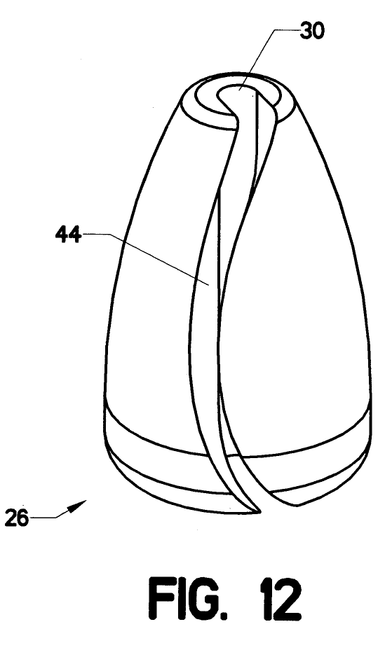

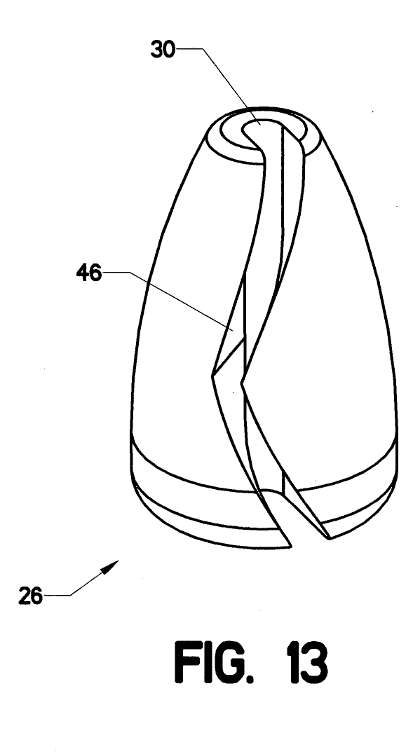

FIGS. 10-13 illustrate the alternate embodiments for the groove. FIG. 10 shows zig-zag groove 40 connected to center bore 30. FIG. 11 shows the use of S-curve groove 42. FIG. 12 shows the use of crescent groove 44. FIG. 13 shows the use of chevron groove 46. All these grooves serve the same purpose as spiral groove 32, in that the line is forced through these grooves into the center bore.

The center bore must still be large enough to pass over the line hardware. The embodiments of the attractant slug shown in FIGS. 10-13 are actually larger overall than the slug shown in FIG. 3. The center bores are the same diameter as the one shown in FIG. 3, but they appear smaller in comparison to the overall size of the attractant slug. The reader should be aware that the attractant slug can be made in many different sizes. Larger sizes can be used with larger lures, or where an extended attractant release time is desired.

The material selected for attractant slug 26 is obviously important. The method of mounting attractant slug 26 on the fishing line allows the use of rigid and substantially rigid materials. However, the material must also slowly dissolve in water in a controllable fashion. One particularly suitable compound is a moldable gelatin in which the fish attractant is dissolved or suspended. Polyglycols can be used as well. Additional specific examples of effective materials include polyglycol 1450, polyglycol 3350, acacia gum, sorbitol, pectin, starch, and a variety of soluble polymers.

The desired scent is then blended with the gelatin while it is still in the liquid state. The liquid is then injected into a cavity mold and allowed to solidify. In this fashion, the shape depicted in FIG. 3 can be molded as one integral unit.

The external profile of attractant slug 26 can affect how it behaves in the water, as well as the rate at which the material dissolves. The bullet shape shown tends to cause turbulent flow near the trailing extreme of the material, which can promote dispersion of the attractant. If a slower dispersion rate is desired, a spherical or teardrop shape can be employed. Those skilled in the art will realize that an endless variety of external shapes are possible.

The actual type of fish attracting agent used is not critical to the present invention. Many different types of attracting agent are well known in the prior art. Examples include meal made of ground and dried squid, shrimp, sardines, bunker, or other bait fishes. Waste materials normally discarded by the canning industry (such as heads, guts, etc.) are also often used. Artificial chemicals can be employed as well. Additional suitable fish attractants include Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

Other materials can be added to the invention as well. As one example, bright colors and microglitter are often employed to attract fish. Fish feeding on natural baits often produce an explosion of reflective scales in the water. The addition of microglitter to the attractant slug causes a release of bright particles as the slug dissolves, which mimics this natural phenomenon (as shown in FIG. 17).

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

Having described my invention, I claim:

1. An attachable fish attractant slug capable of being attached to a fishing apparatus having a fishing line, line hardware, and a lure, comprising:
a. a body, having a leading extreme, a trailing extreme, and an exterior surface;
b. a center bore, running through said body from said leading extreme to said trailing extreme;
c. wherein said exterior surface opens into a non-straight groove connecting said exterior surface to said center bore;
d. wherein said body is formed of a water soluble substance containing fish attractant; and
e. wherein said center bore is larger than said line hardware but smaller than said lure, so that said attractant slug can travel along said fishing line and over said line hardware before coming to rest against said lure.

2. An attachable fish attractant slug as recited in claim 1, wherein said non-straight groove assumes the form of a helix.

3. An attachable fish attractant slug as recited in claim 1, wherein said non-straight groove assumes the form of a zig-zag.

4. An attachable fish attractant slug as recited in claim 1, wherein said non-straight groove assumes the form of an S-curve.

5. An attachable fish attractant slug as recited in claim 1, wherein said non-straight groove assumes the form of a crescent.

6. An attachable fish attractant slug as recited in claim 1, wherein said non-straight groove assumes the form of a chevron.

7. An attachable fish attractant slug as recited in claim 1, wherein said water soluble substance is selected from the group compromising: gelatin, polyglycol 1450, polyglycol 3350, acacia gum, sorbitol, pectin, starch, and a variety of soluble polymers.

8. An attachable fish attractant slug as recited in claim 2, wherein said water soluble substance is selected from the group compromising: gelatin, polyglycol 1450, polyglycol 3350, acacia gum, sorbitol, pectin, starch, and a variety of soluble polymers.

9. An attachable fish attractant slug as recited in claim 3, wherein said water soluble substance is selected from the group compromising: gelatin, polyglycol 1450, polyglycol 3350, acacia gum, sorbitol, pectin, starch, and a variety of soluble polymers.

10. An attachable fish attractant slug as recited in claim 4, wherein said water soluble substance is selected from the group compromising: gelatin, polyglycol 1450, polyglycol 3350, acacia gum, sorbitol, pectin, starch, and a variety of soluble polymers.

11. An attachable fish attractant slug as recited in claim 5, wherein said water soluble substance is selected from the group compromising: gelatin, polyglycol 1450, polyglycol 3350, acacia gum, sorbitol, pectin, starch, and a variety of soluble polymers.

12. An attachable fish attractant slug as recited in claim 6, wherein said water soluble substance is selected from the group compromising: gelatin, polyglycol 1450, polyglycol 3350, acacia gum, sorbitol, pectin, starch, and a variety of soluble polymers.

13. An attachable fish attractant slug as recited in claim 1, wherein said fish attractant is selected from the group comprising: Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

14. An attachable fish attractant slug as recited in claim 2, wherein said fish attractant is selected from the group comprising: Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

15. An attachable fish attractant slug as recited in claim 3, wherein said fish attractant is selected from the group comprising: Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

16. An attachable fish attractant slug as recited in claim 4, wherein said fish attractant is selected from the group comprising: Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

17. An attachable fish attractant slug as recited in claim 5, wherein said fish attractant is selected from the group comprising: Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

18. An attachable fish attractant slug as recited in claim 6, wherein said fish attractant is selected from the group comprising: Menhaden, Shrimp, Pogie, Cigar minnow, Squid, Crayfish, Bluegill, Shad, Spanish Sardine, Boston Mackerel, Bonita, Northern Mackerel, Scallop, Mullet, Garlic, Salt, and synthesized amino acids.

19. A method for placing a fish attractant slug in close proximity to a lure, wherein said lure is attached to a fishing apparatus having a rod, a fishing line extending from said rod, line hardware, and a lure, and wherein said lure is being trolled through the water, comprising:
a. providing a fish attractant slug, including
i. a body, having a leading extreme, a trailing extreme, and an exterior surface;
ii. a center bore, running through said body from said leading extreme to said trailing extreme;
iii. wherein said exterior surface opens into a non-straight groove connecting said exterior surface to said center bore;
iv. wherein said body is formed of a water soluble substance containing fish attractant;
v. wherein said center bore is larger than said line hardware but smaller than said lure, so that said attractant slug can travel along said fishing line and over said line hardware before coming to rest against said lure;
b. attaching said fish attractant slug to said fishing line proximate to said rod by urging said fishing line through said non-straight groove and into said center bore; and
c. releasing said fish attractant slug, so that gravity pulls said fish attractant slug down into said water, where said fish attractant slug will be urged along said fishing line by hydrodynamic forces until it comes to rest against said lure.

20. A method as recited in claim 19, wherein said non-straight groove assumes the form of a helix.
